(19) United States
(12) Patent Application Publication
(10) Pub. No.: US 2005/0010874 A1
(43) Pub. Date: Jan. 13, 2005

(54) Virtual collaborative editing room

(76) Inventors: Steven Moder, Simi Valley, CA (US); Emmanuel C. Francisco, Northridge, CA (US); Richard Rubio, Altadena, CA (US); James F. Beshears, San Marino, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/615,337

(22) Filed: Jul. 7, 2003

(51) Int. Cl. G09G 5/00

(52) U.S. Cl. 715/751; 715/753; 715/758; 715/759; 715/756

(57) ABSTRACT

A room designed for collaboration and personal interaction during the editing process by parties situated in different locations. At a source location, an operator transmits media content from an editing system to a target location. At the target location, another operator uses a remote control to control the editing system's playback of the media content. The target operator can overlay graphics, text and other information on the media content. This commentary overlay is then sent back to the source location. A high-resolution video teleconferencing system allows personal real-time interaction between the source operator and target operator. The video teleconferencing system provides for direct eye-to-eye contact as well as control of audio levels for realistic conversation between the source and target operators.

### TECHNICAL FIELD

This invention relates generally to the film editing process and, more particularly, to providing collaboration and personal interaction during editing by parties situated in different locations.

### BACKGROUND

From the day the first scene is shot to the day the product makes it into the can, the editing process requires a precise and detailed collaborative effort from both the director and the editor. It is the director who interprets the script and oversees all creative aspects of the production. The editor selects and orders the shots into sequences to form the continuity of the story, creating drama and pacing to fulfill the director's vision of the story. In addition, the editor adds the sound, titles, transitions and special effects. The editor also reviews the dailies to ensure that all necessary shots for a sequence were taken at a particular location and to ensure that no technical problems occurred while filming (e.g., the camera was out of focus). Editing frees the director to film out of order, to make multiple takes of each shot and allows for aesthetic decisions to be made after filming is completed.

With the development of digital video and non-linear editing, many directors shoot on film, which is then transferred to time-coded videotape or digital files for easier editing. This time-coded videotape can then be edited using non-linear editing equipment. These advancements allow the editor and director to collaboratively experiment with a variety of different shot combinations that can be shown instantly on a bank of video monitors.

The problem arises in the collaborative editing process when the editor and director are not at the same location. Without the director's direct input, the editor must make assumptions as to the director's objective and vision for the product. This occurs when the script notes are incomplete or absent or if the product is a documentary. The editor ships the media content with the editor's cuts to the director for approval. If the editor guesses incorrectly, post-production could be delayed while waiting for director's comments and further delayed if the product needs to be re-edited. The delays could be significant if the director is busy and does not review the editor's work in a timely manner. Any delay in post-production is costly.

Alternatively, the director must travel to where the editor is located. In many cases, requiring the director to come to the editor's location is not practical or economical. For example, it is not practical for the director to travel to the editor in the case of a distributed filmmaking company which is located in many separate facilities and has established different sites for editing, production, storyboarding, etc. In this case, the schedule and budget would have to include extra time and cost for the director to travel to the editing site. Additionally, the director's travel may not be practical or economical if the director is working on completion of other parts of the same film, or other films. These projects would have to be halted in order for the director to travel to the editor and complete the editorial process.

One way in which an editor and director can work together from different and distant locations is by video teleconferencing. In a conventional video teleconference, each site has one or more video cameras and one or more video monitors as well as an audio capture and amplification system. The camera captures the participant at one site, and the video and sound are transmitted to the other site, where the captured video is displayed on the video monitor. In some cases, external video inputs, such as videotape players, computers or the like may be used to provide the video content.

However, this approach does not give the editor and director sufficient ability to collaborate. The editor still has to prepare the rough edit of the product beforehand and then play it back as input on the video teleconference system. The director sees the rough edit on his local video monitor, but is generally limited to verbally instructing the editor as to when to start, pause or replay a section of the footage, and then must explain what further changes need to be made. The conventional format of a video teleconference further substantially reduces the participants' perception of directly working together, since many non-verbal cues such as direct eye contact, body language, etc., are typically lost due to the low quality of the video signal and the physical arrangement of the camera and monitor.

In addition, traditional video teleconferencing equipment is configured to work standalone at one location. This means traditional video teleconferencing equipment makes no assumptions about the physical layout or technical capabilities of the location to which it is transmitting its content. Although this typically reduces cost and attracts more customers, it limits the overall ability to collaborate and to create a shared environment since it fails to take advantage of the ability to configure the overall design and functionality of both locations.

What is needed is a method for personal interaction and collaboration between the editor and director during the editing process when the parties are situated in different locations. It is desirable to provide a more intimate video teleconferencing system that allows for more direct personal interaction, so as to provide a virtual collaborative editing room.

### SUMMARY OF THE INVENTION

The present invention allows for intimate collaboration and personal interaction during the editing process between parties situated in different locations. In one embodiment of the invention, a source location and a target location are connected over a network to transmit video and audio between the two locations; both locations have video and audio capture apparatuses, video displays, and audio output devices. The source location further includes, an editing system that outputs media content for transmission to a target location during an editing session. The target location includes, a remote playback controller that an operator, such as a director, uses to view the media content on the video display and control the playback of the media content on the editing system at the source location. In addition, both the target and source locations include a computer system enabling both operators to overlay graphics, text, or other information on the media content; this additional information is transmitted from one location to the other where it can be viewed by the other operator as overlays on the media content display on the second location's video display.

Preferably, at least one location, such as the target location, includes a virtual eye-to-eye video capture and display apparatus. This apparatus includes a video camera positioned behind a beam splitter to capture the operator's direct gaze at the video display so as to appear on the other location's video display as though the operator is looking directly at the other operator, thereby providing a sense of direct eye-to-eye contact between the operators. This perception of eye contact further enhances the working experience and sense of collaboration. The eye-to-eye capture apparatus also displays the captured images at about the scale and distance that further reinforces the feeling of personal contact.

The features and advantages in this summary and the follow detailed description are not all-inclusive. Many additional features and advantages will be apparent to one of ordinary skill in the art in view of the drawings, specification, and claims hereof. Moreover, it should be noted that the language used in this disclosure has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a plan view of a source location according to an embodiment of the present invention.

FIG. 2 is a plan view of a target location according to an embodiment of the present invention.

FIG. 3 is a front elevation of a target location according to an embodiment of the present invention.

FIG. 4 is a side elevation of a target location according to an embodiment of the present invention.

FIG. 5A is a block diagram of the video display pathway for the video teleconferencing system at the source location according to an embodiment of the present invention.

FIG. 5B is a block diagram of the media content pathway and the video capture pathway at the source location according to an embodiment of the present invention.

FIG. 6A is a block diagram of the video capture pathway for the video teleconferencing system at the target location according to an embodiment of the present invention.

FIG. 6B is a block diagram of the media content pathway and the video display pathway at the target location according to an embodiment of the present invention.

FIG. 7 is a block diagram of the audio capture pathway at the source location according to an embodiment of the present invention.

FIG. 8 is a block diagram of the audio capture pathway at the target location according to an embodiment of the present invention.

FIG. 9 is a block diagram of the editing control console and annotation computer system pathway and the audio level control pathway according to an embodiment of the present invention.

The accompanying drawings illustrate several embodiments of the invention and, together with the description, serve to explain the principles of the invention. The figures depict various preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The present invention is now described more fully with reference to the accompanying figures, in which several embodiments of the invention are shown. The present invention may be embodied in many different forms and should not be construed as limited to the embodiments set forth herein. Rather these embodiments are provided so that this disclosure will be thorough and complete and will fully convey the invention to those skilled in the art.

A virtual collaborative editing room generally comprises of a target location and at least one source location. The locations are communicatively coupled by a network connection. An operator at the source location produces media content. The media content can be edited video but other embodiments are possible and include, for example, media files such as static image files; audio, such as wav, mp3, etc, files; CAD/CAM files; recorded notes or any other content.

The media content is transmitted via the network to the target location from an editing system at the source location. An operator at the target location is then able to conduct a review of the media content by remotely controlling the editing system as well as to overlay text, graphics or other information over the media content by use of a computer system. Both the source and target operators are able to interact through the use of real-time high-resolution video teleconferencing, which allows direct eye-to-eye contact between the operators throughout the editing process. Each aspect of the present invention will be more thoroughly developed below.

A. Source Location

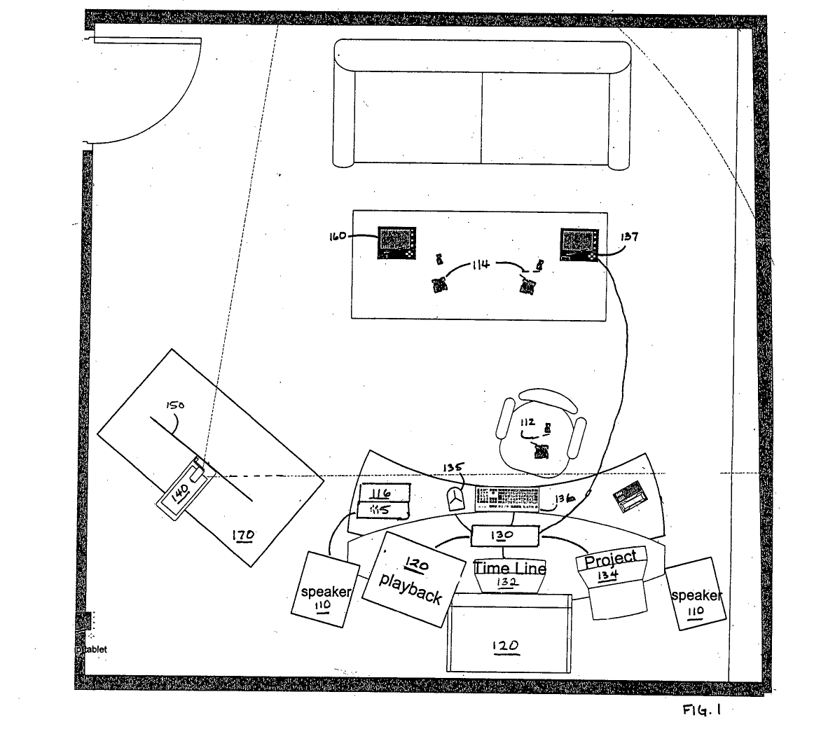

FIG. 1 is a plan view of a source location according to an embodiment of the present invention. The source location includes a non-linear editing system 130. The non-linear editing system 130 is coupled to media content playback screen 120 and to an audio system 115. The non-linear editing system 130 also is coupled to various output monitors for displaying an editor timeline (monitor 132) and project media files and data (monitor 134). The source operator controls the non-linear editing system 130 with standard input devices including a mouse 135, keyboard 136 and an automated session and volume control panel 137. The source operator can overlay informational annotations over the media content through the use of a computer system 160. In addition, the source location includes a video teleconferencing system 170 including a video teleconferencing camera 140 for capturing the source operator as he controls the non-linear editing system 130. Also included is a video teleconferencing display screen 150 for displaying the received images of the target operator at a target location.

The audio system 115 comprises of microphones including, for example, a wireless microphone 112 and gooseneck microphones 114; equalization equipment 116 which carry the audio remotely to the target without delay or noise; and speakers 110 for audio output. For example, in one embodiment, the audio system 115 can comprise of a ClearOne Communications, Inc.'s XAP 800 audio conferencing system; an amplifier; several microphones including a Shure ULX-J1 wireless microphone system with super miniature cardoid lavaliere microphones, cardoid miniature microphones, and Shure MX412/D gooseneck microphones; a test/signal generator; and studio quality speakers. Simultaneous conversation (full duplex) between the source operator and the target operator is captured through the use of special electronics embedded in both the source and target locations. An example of the special electronics is the use of the ClearOne XAP 800 echo cancellation capabilities to eliminate feedback.

The non-linear editing system 130 can be an Avid Technology non-linear editing system, but could also be a Lightworks, Inc., Media 100, Inc., Apple Computer's Final Cut Pro, Quantel, Inc.'s editing tools, editing products from Discreet, a division of Autodesk, Inc., Alpha Space's VideoCube, D-Vision, Inc., or any other such system that can be used for non-linear editing.

The source operator typically edits media content by using the non-linear editing system 130 and transmits this product via a network connection to the target location. The media content can be transferred across the network in any of the following file formats: Open Media Framework (OMF), Quicktime, Audio Interchange File Format (AIFF), Sound Designer II (SD2), Tagged Image File Format (TIFF) file formats or any other type of file formats or in any combination of file formats.

The automated session and volume control panel 137 starts the editing session, begins the recording of the editing session, and manipulates the audio system levels from non-linear editing system 130 to allow for more realistic conversation audio levels from the video teleconferencing system. The automated session and volume control panel 137 can be an AMX Corporation's Central Controller or any other type of similar controller.

The computer system 160 allows the source operator to overlay graphics, text or other information onto the media content. This overlaid information is inputted into the video teleconferencing system and transmitted to the target location to be viewed by the target operator as overlaid information on the target location's media content display 320. The computer system 160 can include an IDE, Inc. 710 AVT touch screen with video overlay or any other type of computer system, which permits annotations over media content.

Additionally, the source operator can personally interact with the target operator through the use of a real-time video teleconferencing system 170 comprising of the audio system 115, video teleconferencing camera 140, and the video teleconferencing display screen 150.

The video teleconferencing system 170 uses SD resolution and produces high quality video through the use of MPEG-2 compression, high-resolution display systems 150 such as 50″ widescreen high-definition (HD) plasma display panels, high quality CODECs such as the Miranda Technologies, Inc. MAC-500 MPEG-2 encode/decode card, and high quality cameras 140, such as Panasonic ⅓″ 3-CCD C-mount convertible camera system. The video teleconferencing signals are sent encoded to minimize bandwidth use while maintaining near quality of the original image. These technological upgrades help to eliminate image blockiness, blurring and delay commonly associated with typical video teleconferencing systems.

In addition, the source room configuration, camera placement, and lighting are configured in such a way that it optimizes the “in-person meeting” feeling of the video teleconference. This includes recessed fluorescent and incandescent lighting and the use of fill lights behind the operators. The lighting levels should be 3200K to 3500K depending on the room size. In addition, the lighting should include soft light sources placed close to the camera to create “flat” light so as to not contribute to shadows or hot spots. Image size in the display screens should be as close to life size as possible.

B. Target Location

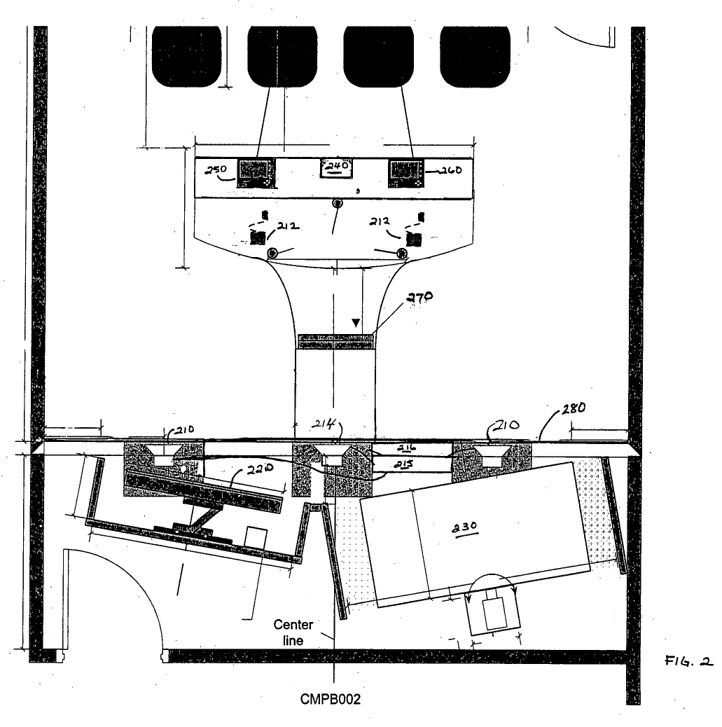

FIG. 2 is a plan view of a target location according to an embodiment of the present invention. The target location includes a media content display 220 to display the media content transmitted from the source location. The media content display 220 is coupled to an editor timeline 270. In addition, the media content display 220 is coupled to an audio system 215. A remote non-linear editing control console 240 controls the non-linear editing system 130 at the source location. An automated session and volume control panel 260 controls the audio level of the media content display 220 in the target location. In addition, graphics, text and other information can be overlaid over the media content by use of a computer system 250. A video teleconferencing system 230 is used to provide eye-to-eye visual contact between the source operator and the target operator over a video interface. The video teleconferencing system 230 will be discussed at greater length below.

The media content display 220 allows for the viewing and playback of the audio and media content from the source location's non-linear editing system 130. The editor timeline 270 allows for the viewing of the same non-linear editing timeline as displayed on monitor 132 at the source location. The remote non-linear editing control console 240 provides remote playback control over the media content display 220 and the source location's media content playback screen 120 by remotely controlling the non-linear editing system 130. The editing control console 240 allows the target operator, such as the director, to move through the media content in a manner similar to a videotape player control, (i.e., start, stop, fast forward, rewind, shuttle/jog, pause, etc.). The editing control console 240 can be a DNF Controls' ST100 Controller that uses a RS-422 standard protocol interface but any other comparable device can be used. A control server converts the editing control console's 240 control commands from RS-422 protocol to IP for network transmission. The control server can be a Lantronix, Inc. SCS 200 or any other similar device.

The automated session and volume control panel 260 can automatically increase, decrease or mute the soundtrack of the media content to allow for more realistic conversation between the source and target operators through the video teleconferencing system 230. The automated session and volume control panel 260 can be an AMX Corporation's Central Controller or any other type of similar controller.

The computer system 250 allows the target operator to overlay graphics, text or other information onto the media content. This overlaid information is inputted into the video teleconferencing system and transmitted back to the source location to be viewed by the source operator as overlaid information on the source location's media content display screen 120. The computer system 250 includes an IDE, Inc. 710 AVT touch screen with video overlay or any other type of computer system, which permits annotations over media content.

The target audio system 215 is similar to the source audio system 115 in that it consists of special microphones 212, equalization equipment 216 and high-end speakers 210 and 214. The purpose of both the source audio system 115 and target audio system 215 is to provide seamless interactive audio sessions between the source and the target. However, separate audio monitors exist for video teleconferencing and for the audio portion of the media content from the non-linear editing system 130 at the source location.

Throughout the review and commenting phase of editing, the target operator and source operator will be additionally personally interacting through the use of a real-time video teleconferencing system 230. This system is comprised of many of the same components as described above for the source location. In one embodiment, the real-time video teleconferencing system 230 is housed recessed behind a wall 280 at the target location, as shown in FIG. 2. However, the system need not be recessed. Using this system, the source operator will better understand the editorial comments made by the target operator because the source operator will be in visual contact with the target operator during the entire editing session.

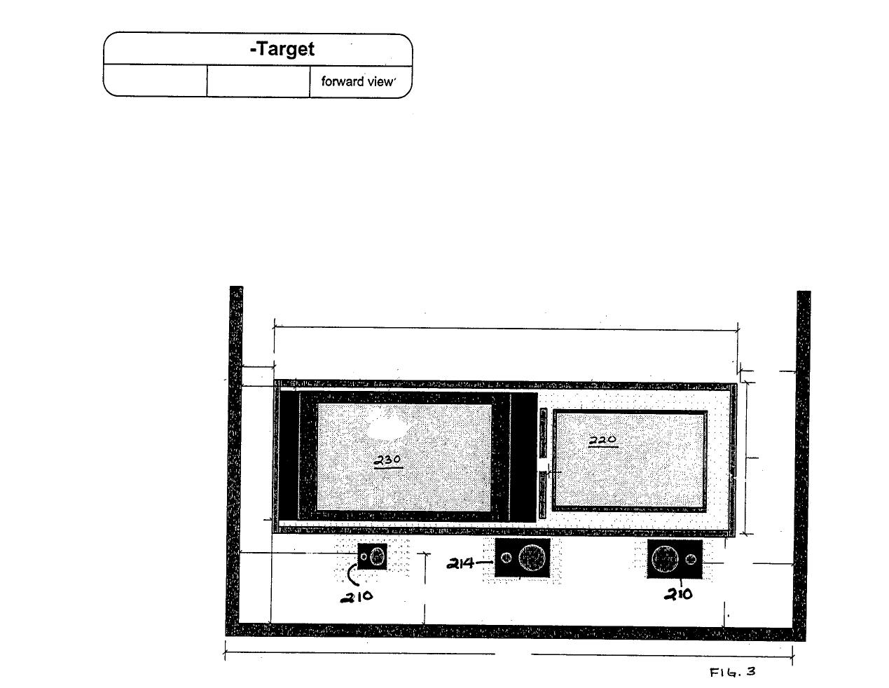

FIG. 3 is a front elevation of a target location according to an embodiment of the present invention. FIG. 3 illustrates the view the target operator has of the video teleconferencing system 230, the media content display 220, the video teleconferencing system 230 speaker 214 and the non-linear editing system 130 speakers 210. The video teleconferencing system 230 displays the received images of the source operator at the source location. The media content display 220 displays the media content from the non-linear editing system 130 for review and playback.

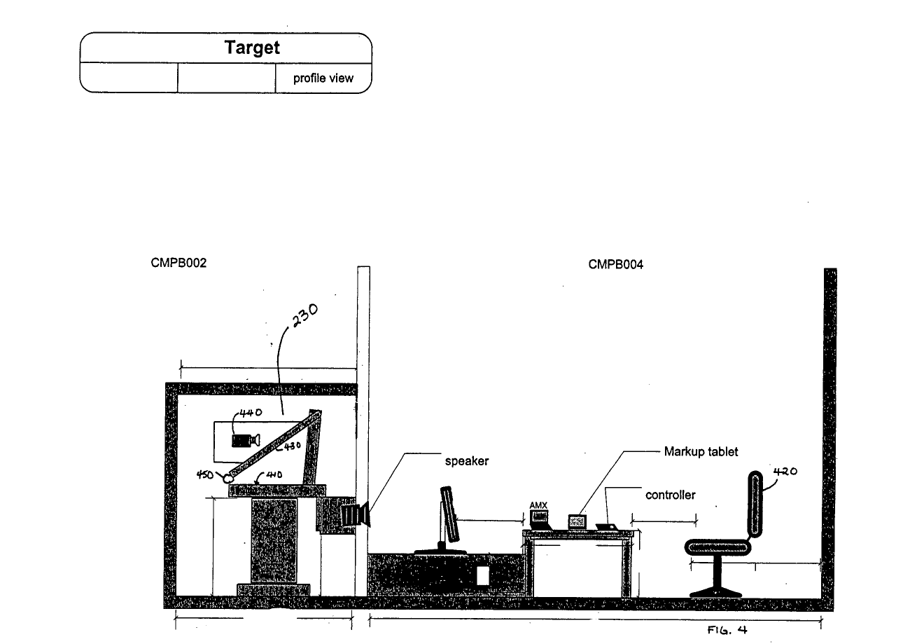

FIG. 4 is an elevation view of a target location according to an embodiment of the present invention. This illustration shows the physical arrangement of the video teleconferencing system 230 as described above.

The video teleconferencing system 230 includes a video display screen 410 that is positioned with the screen face up at a slight angle (approximately 15 degrees) to the floor. The top of the video display screen 410 (with respect to the orientation of the image to be displayed) is located towards the target operator's chair 420. The beam splitter 430 has a reflective coating applied to approximately 60% of one side. If the lighting levels are kept brighter on the reflective side of the beam splitter, the side with the reflective coating acts like a mirror and the side without the coating acts like a tinted window.

The beam splitter 430 is supported by an armature 450 that enables adjustment of the angle of the beam splitter 430 relative to the video display screen 410. Preferably the beam splitter 430 has the reflective side facing the video display screen 410 at an angle that permits the reflection of the image in the video display screen 410 to appear to the target operator sitting in the chair 420 as if the image displayed in the video display screen 410 was upright and at eye level to the target operator.

Behind the beam splitter 430 is a target-capturing camera 440. The light levels behind the beam splitter 430 are kept sufficiently low and no direct light is pointed towards the beam splitter 430 so that the target operator cannot see the camera. The target-capturing camera 440 is positioned behind the reflected image of the video display screen 410 on the beam splitter 430, and at a height that enables it to capture the direct eye gaze of the target operator sitting in the chair 420. The image captured is then transmitted back to source location for display on the video teleconferencing display screen 150.

The position of the cameras, the sizing of the images, as well as the lighting levels produces the effect that the source operator and the target operator are talking to each other with eye-to-eye contact. The perception that the two operators are speaking eye-to-eye further enhances the working experience and the sense of collaboration.

C. Audio and Video Networking Architecture

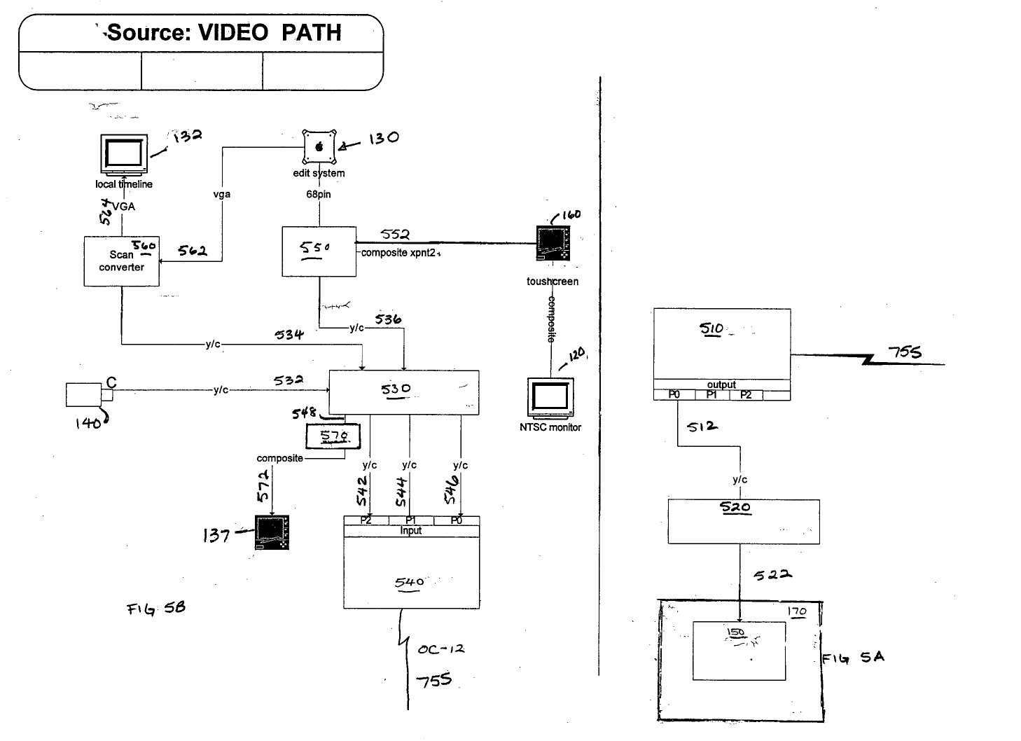

FIG. 5A is a block diagram of the video display pathway for the video teleconferencing system 170 at the source location according to an embodiment of the present invention. The video pathway is used to route video between the source location and the target location. The video pathway includes a media content switcher 520, a video teleconferencing display 250, a multimedia access MPEG2 CODEC 510 and a synchronous network 755. The synchronous network 755 provides an electronic connection between the source and target locations. The network is preferably an OC-12 network or, at the minimum, a DS3 network.

The multimedia access MPEG2 CODEC 510 receives input from the network 755, decodes the input, and sends output 512 to the media content switcher 520. The media content switcher 520, in turn, sends the output 522 to the video teleconferencing system 170 for display on the video teleconferencing display 250.

Preferably the multimedia access MPEG2 CODEC 510 is a Miranda Technologies, Inc. MAC-500. The media content switcher 520 can be an Extron Electronics MediaLink switcher or any other type of audio/video media switcher.

FIG. 5B is a block diagram of the media content pathway and the video capture pathway at the source location according to an embodiment of the present invention. This pathway is used to route media content from the non-linear editing system 130 and video from the video teleconferencing camera 140 at the source location to the target location. The media content pathway includes a media content switcher 530, a multimedia access concentrator 540, a scan converter 560, a video converter 570, a video teleconferencing camera 140, a non-linear editing system 130, an automated session and volume control panel 137 and an interface to the network 755.

The media content switcher 530 receives three inputs (532, 534, and 536). Input 534 is output from the scan converter 560, which receives two inputs in VGA mode; one input 564 from the editor timeline 132 and the other input 562 from the non-linear editing system 130 and coverts the signals to Y/C video format as output 534. Input 536 is from an I/O broadcast breakout box 550 of the non-linear editing system 130. Input 532 is from the video teleconferencing camera 140. In addition, the I/O broadcast breakout box 550 sends a composite video output 552 to the computer system 160 for display of the informational annotations over the media content on the media content playback screen 120.

The media content switcher 530 sends output 548 to the video converter 570, which converts the Y/C video format input 548 to composite video output 572. The composite video output 572 is then inputted to the automated session and volume control panel 137. The media content switcher 530 sends three MPEG-2 compressed media outputs, 542, 544 and 546, as inputs to the multimedia access concentrator 540, which concentrates the media onto the network 755.

Preferably the multimedia access concentrator 540 is a Miranda Technologies, Inc. MAC-500. The media content switcher 530 can be an Extron Electronics MediaLink switcher or any other type of audio/video media switcher.

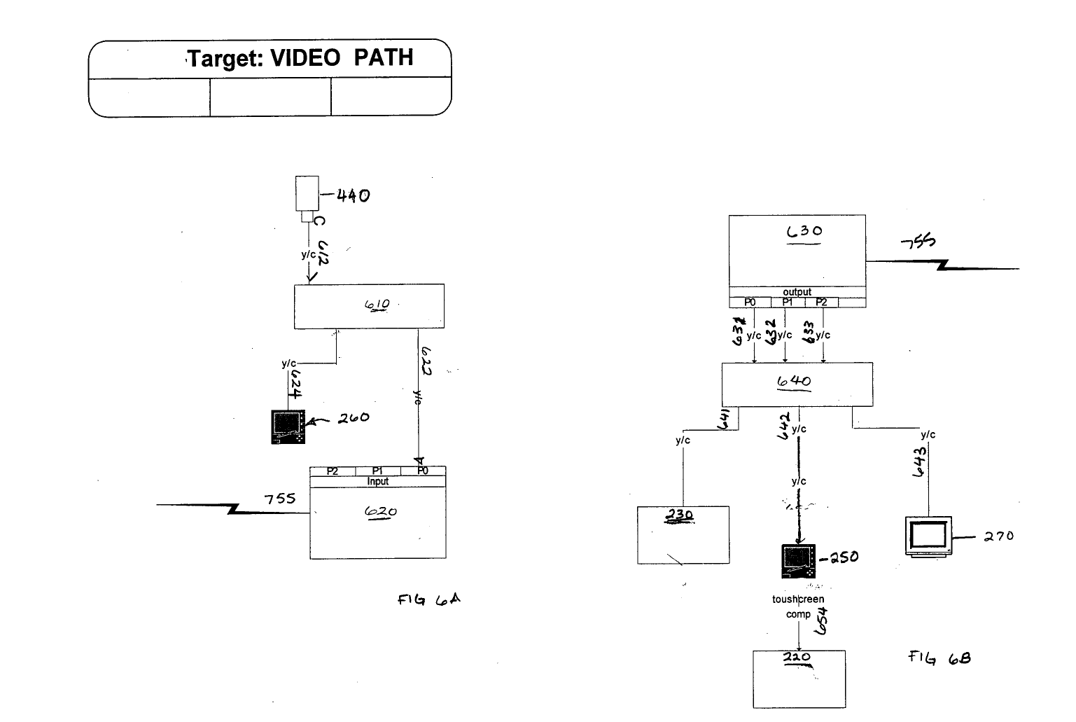

FIG. 6A is a block diagram of the video capture path for the video teleconferencing system 230 at the target location according to an embodiment of the present invention. The video pathway is used to route video between the target location and the source location. This video pathway includes a media content switcher 610, a video teleconferencing camera 440, a multimedia access concentrator 620, an automated session and volume control panel 260, and an interface to the synchronous network 755.

The media content switcher 610 receives input 612 from the video teleconferencing camera 440. The media content switcher 610 sends output 624 to the automated session and volume control panel 260 and sends MPEG-2 compressed media output 622 to the multimedia access concentrator 620, which concentrates it onto the network 755.

Preferably the multimedia access concentrator 620 is a Miranda Technologies, Inc. MAC-500. The media content switcher 610 can be an Extron Electronics MediaLink switcher or any other type of audio/video media switcher.

FIG. 6B is a block diagram of the media content pathway and the video display pathway at the target location according to an embodiment of the present invention. This pathway is used to display the media content from the non-linear editing system 130 and the captured video from the video teleconferencing camera 140 from the source location at the target location. This pathway includes a media content switcher 640, a video teleconferencing display 230, editor timeline 270, a computer system 250, a media content display 220, a multimedia access concentrator 630, a video converter 650, and an interface to the synchronous network 755.

The multimedia access concentrator 630 receives input from the network 755 decodes the input and sends three outputs (631-633) to the media content switcher 640. The media content switcher 640, in turn, sends three outputs (641-643) to various displays. Output 641 is sent to the video teleconferencing display 230 for display of the received images of the source operator. Output 643 is sent to the timeline 270 for display of the video timeline. Output 642 is sent to the computer system 250, which adds the overlays of informational annotations over media content as output 654. Output 654 is then displayed on media content display 220.

Preferably, the multimedia access concentrator 630 is a Miranda Technologies, Inc. MAC-500. The media content switcher 640 can be an Extron Electronics MediaLink switcher or any other similar type of audio/video media switcher.

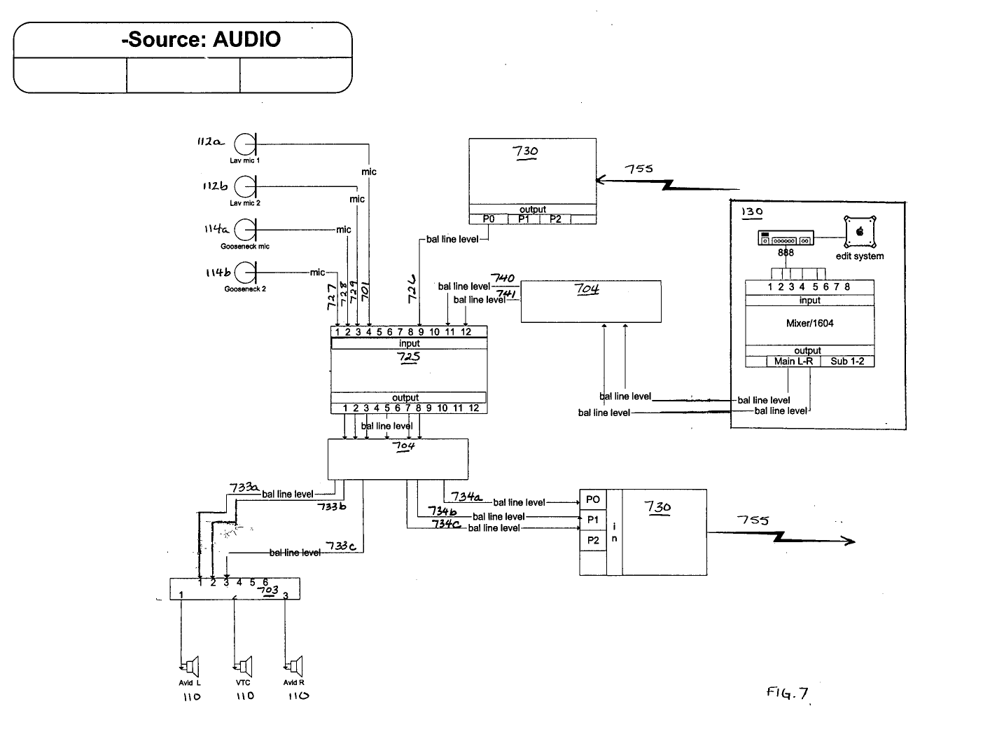

FIG. 7 is a block diagram of the audio capture path at the source location according to an embodiment of the present invention. The audio capture system and the audio amplification system enable the capture and projection of sound respectively at the source location. This audio pathway includes an audio switch 725, an encoder/decoder 730, a media content switcher 704, an amplifier 703, and a synchronous network 755.

The audio switch 725 has a plurality of input audio signals, one audio input signal 727, 728, 729, or 701 from each microphones 112a-b and 114a-b of the audio system 115 at the source location, a pair of audio signals 740 and 741 from a media content switcher 704 coming from the non-linear editing system 130 at the source location and one audio input signal 726 from the audio system 215 at the target location. The audio switch 725 also has output signals 733a-c and 734a-c, which are coupled to the media switcher 704. From the media content switcher 704, three output audio signals, 733a-c, are coupled to a power amplifier 703 for amplification and projection through the speakers 110 of the audio system 115 at the source location. The audio switch 725 is capable of selecting one input audio signal among a plurality of input audio signals and mixing several input audio signals to produce a single output audio signal.

The encoder/decoder 730 has an input 755 and an output 726. The output 726 is input into the audio switch 725. The encoder/decoder 730 is capable of decompressing an audio signal from its input 755. In addition, the encoder/decoder 730 has inputs 734a-c from the media content switcher 704 and an output 755. The encoder/decoder 730 is capable of compressing an audio signal from its inputs.

In a preferred embodiment, the audio switch 725 is a ClearOne Communications, Inc., XAP 800 switch that has distributed echo and noise cancellation, filtering and mixing capabilities. Additionally, the encoder/decoder 730 is a Miranda Technologies, Inc. MAC-500 concentrator. The media content switcher 704 can be an Extron Electronics MediaLink switcher or any other type of audio/video media switcher.

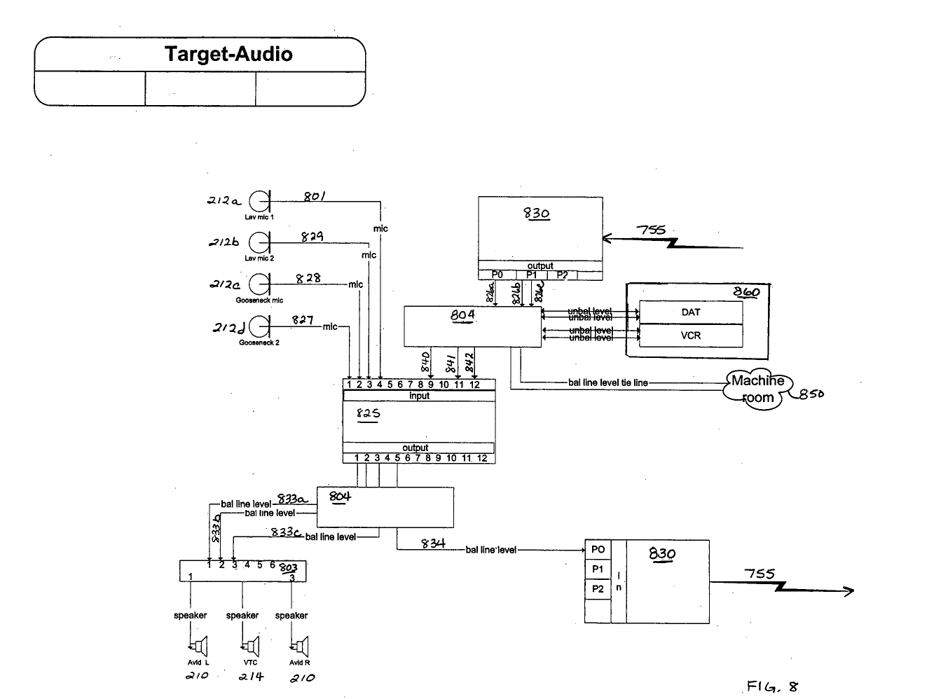

FIG. 8 is a block diagram of the audio capture path at the target location according to an embodiment of the present invention. The audio capture system and the audio amplification system enable the capture and projection of sound respectively at the target location. This audio pathway includes an audio switch 825, an encoder/decoder 830, a media content switcher 804, an amplifier 803, and a synchronous network 755.

The audio switch 825 has a plurality of input audio signals, one audio input signal 827, 828, 829, or 801 from each microphones 212a-d of the audio system 215 at the target location, three audio signals 840, 841, and 842 from a media content switcher 804. The media content switcher 804 receives audio input signals 826a-c from the encoder/decoder 830. In addition, the media content switcher 804 sends and receives input to and from recording equipment 860 in the target location. The recording equipment 860 can include a VCR, DAT, or any other equipment use to record the editing process. The media content switcher 806 also communicates with a machine room 850. The machine room 850 houses additional audio/visual equipment.

The audio switch 825 also has output signals 833a-c and 834, which are coupled to a media switcher 804. From the media switcher 804, three output audio signals, 833a-c, are coupled to a power amplifier 803 for amplification and then projection through the non-linear editing system speakers 210 and the video teleconferencing speaker 214 of the audio system 215 at the target location. The audio switch 825 is capable of selecting one input audio signal among a plurality of input audio signals and mixing several input audio signals to produce a single output audio signal.

The encoder/decoder 830 has an input 755 and an output 826a-c. The output 826a-c is input into the media content switcher 806. The encoder/decoder 830 is capable of decompressing an audio signal from its input 755. In addition, the encoder/decoder 830 has inputs 834 and an output 755. The encoder/decoder 830 is capable of compressing an audio signal from its inputs.

In a preferred embodiment, the audio switch 825 is a ClearOne Communications, Inc., XAP 800 switch that has distributed echo and noise cancellation, filtering and mixing capabilities. Additionally, the encoder/decoder 830 is a Miranda Technologies, Inc., MAC-500 concentrator. The media content switcher 804 can be an Extron Electronics MediaLink switcher or any other type of audio/video media switcher.

D. Editing Control

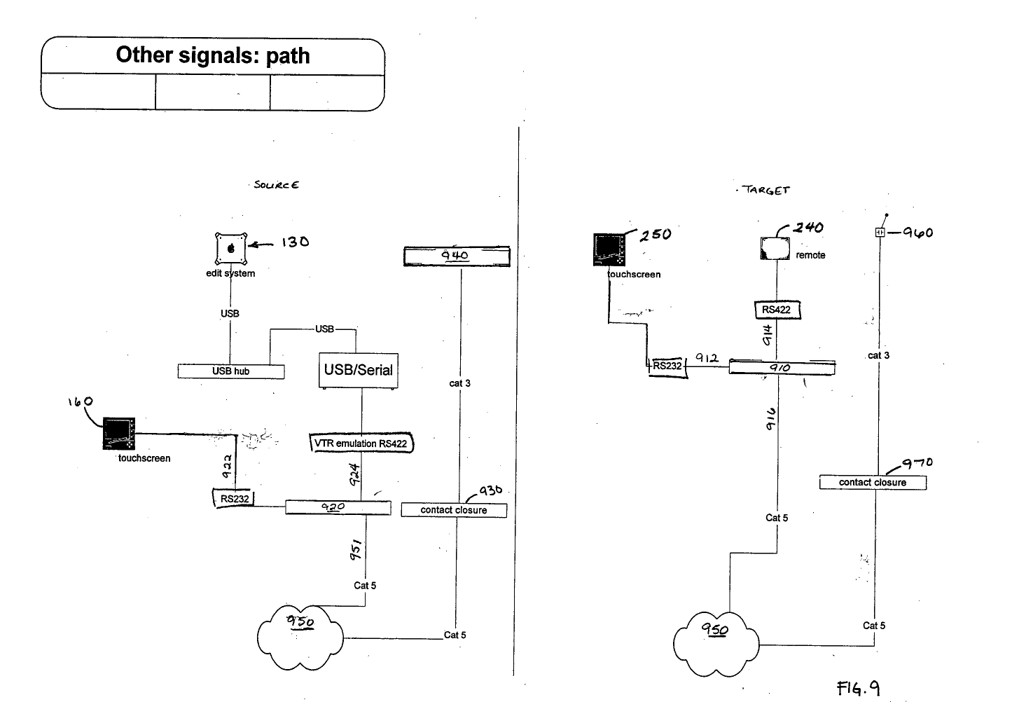

FIG. 9 is a block diagram of the editing control console and annotation computer system pathway and the audio level control pathway according to an embodiment of the present invention. This pathway includes two console servers, one at the target location 910 and one at the source location 920; two contact closures, one at the target location 970 and one at the source location 930; an audio switch 960; an audio interface 940; a computer system 160 at the source location; a computer system 250 at the target location; an editing control console 240; a non-linear editing system 130 and a network 950.

The source console server 920 receives two inputs, 922 and 924. Input 922 is received from the source computer system 160 in RS-232 standard protocol. This input 922 contains the informational annotations created by the source operator on the computer system 160, which are to be overlaid over the media content. Input 924 is received from the non-linear editing system 130 in RS-422 standard protocol. This input 924 contains the non-linear editing system 130 editing control commands for controlling the view of the media content on the media content playback screen 120 at the source location as well as the media content display 220 at the target location. The source console server 920 converts the two inputs, 922 and 924, to IP and sends an output 926 to the network 950 for transfer to the target location.

The target console server 910 receives two input signals, 912 and 914. Input signal 912 is received from the target computer system 250 in RS-232 standard protocol. Input 912 contains the informational annotations created by the target operator on the computer system 250, which are to be overlaid over the media content. Input signal 914 is received from the editing control console 240 in RS-422 standard protocol. Input 914 contains commands from the editing control console 240 for controlling the non-linear editing system 130 at the source location. The target console server 910 converts the two inputs, 912 and 914, to IP and sends an output 916 to the network 950 for transfer to the source location. Preferably, the console servers are Lantronix, Inc., SCS 200 but can be any type of secure console server.

The audio switch 960 allows the target operator to remotely control the audio levels at the source location. When the target operator changes the state of the audio switch 960, the state change is sent to the target contact closure 970. The target contact closure 970, in turn, relays the state change of the audio switch 960 to the network 950. At the source location, the source contact closure 930 receives the state change of the audio switch 960 and relays the state change to the audio interface 940. The audio interface 940 sends a signal to the audio system 115, which triggers the audio system 115 to adjust the audio levels at the source location. The audio switch 960 can be part of automated session and volume control panel 260.

Having described embodiments of a virtual collaborative editing room (which are intended to be illustrative and not limiting), it is noted that modifications and variations can be made by persons skilled in the art in light of the above teachings. It is therefore to be understood that changes may be made in the particular embodiments of the invention disclosed that are within the scope and spirit of the invention as defined by the appended claims and equivalents.

1. A method of collaboratively editing in real-time, the method comprising:
transmitting the media content from the non-linear editing system at the source location to a target location;
displaying the media content simultaneously at both the target and source locations;
manipulating remotely audio levels during editing;
controlling playback of the media content by the non-linear editing system at the source location by an editing control console at the target location;
overlaying information over the media content at the target location; and
sending the overlay information to the source location.

2. The method of claim 1 wherein overlaying further comprises:
utilizing a computer system at the target location to add graphics, text and other information to the media content.

3. A method of video teleconferencing, the method comprising:
capturing video and audio at a source location;
transmitting source video and source audio to a target location;
broadcasting source audio over target audio system;
displaying source video at the target location on a display screen oriented generally face up;
reflecting source video into a two-way mirror positioned at an angle such that the source video is displayed on the two-way mirror at eye level to the target operator;
capturing target video at the target location from a target capturing camera positioned behind the two-way mirror in such way that the capturing camera is about eye level to the target operator;
obtaining target audio at the target location; and
sending captured target video and target audio for display and broadcast at the source location.

4. The method of claim 3 wherein sending further comprises:
recording the target video and audio at the source location for play back at a later time or at a location other than the source location.

5. A system for providing media content to a target location, the system comprising:
a non-linear editing system and an audio system for the creation of the media content, the non-linear editing system adapted to playback the media content in response to a editing control console at the target location;
a video teleconferencing screen for display of a target operator; and
a camera positioned to capture the source operator for display at the target location.

6. A system for display of media content from a source location, the system comprising:
a display screen to display media content from source system;
an audio system;
an editing control console to remotely control the media content at both the source location and the target location;
a volume control to control the audio system at both the source location and the target location;
a computer system to overlay comments onto the media content;
a video teleconferencing screen for an eye-level display of the source operator;
a two-way mirror to reflect the video teleconferencing screen display to the target operator at eye-level; and
a camera for capturing the target operator at eye level for display at the source location.

7. A video teleconferencing system for displaying and capturing video at eye level at the target location, the system comprising:
a video display screen positioned face up to display an image of a source operator;
a two-way mirror hung at an angle above the video display screen so that the reflective side reflects the video display screen image back to a target operator at eye-level;
a camera positioned on the non-reflective side of the two-way mirror to capture the target operator at eye-level, and
an audio system for capturing sound.
